(19) United States
(12) Patent Application Publication
(10) Pub. No.: US 2026/0204992 A1
(43) Pub. Date: Jul. 16, 2026

(54) SYSTEM AND METHOD FOR MAGNETIZING RARE EARTH METALS TO CONSTRUCT A ROTOR ASSEMBLY

(71) Applicant: SIMPLEENERGY PRIVATE LIMITED, Bengaluru, Karnataka (IN)

(72) Inventors: Vigneswaran S, Bengaluru (IN); Devanathan S, Bengaluru (IN); Mugilan MEIBALAN, Bengaluru (IN); Sheetal N SHETTY, Bengaluru (IN)

(73) Assignee: SIMPLEENERGY PRIVATE LIMITED, Bengaluru, Karnataka (IN)

(21) Appl. No.: 19/135,197

(22) PCT Filed: Dec. 7, 2023
(86) PCT No.: PCT/IB2023/062346

§ 371 Date: Jun. 3, 2025

(30) Foreign Application Priority Data
Dec. 7, 2022 (IN) 202241070714

(51) Int. Cl. H02K 15/038; H02K 1/276

(52) U.S. Cl. CPC H02K 15/038; H02K 1/276

(57) ABSTRACT

A system to magnetize one or more rare earth metals includes one or more laminated sheets. The one or more laminated sheets are stacked together to construct a laminated block. The one or more stacked laminated blocks are stacked together to construct a rotor assembly. The rotor assembly includes one or more surfaces on an outer periphery. The rotor assembly includes one or more slots that provide a predetermined space to position the one or more rare earth metals in a non-magnetized state. The system further includes a magnetization unit. The magnetization unit includes one or more magnetizing surfaces and one or more magnetizing windings. The one or more magnetizing surfaces magnetize the one or more rare earth metals of the rotor assembly by passing a predetermined supply.

### BACKGROUND

### Technical Field

The embodiments herein generally relate to a rotor assembly of an electrical machine, and more particularly, to a system and method for magnetizing one or more rare earth metals to construct the rotor assembly of the electrical machine. The present application is based on, and claims priority from an Indian Provisional Application Number 202241070714 filed on Jul. 12, 2022, the disclosure of which is hereby incorporated by reference herein.

### Description of the Related Art

Nowadays, automobile manufacturers, particularly those specializing in electric vehicles, prefer permanent magnet (PM) electrical machines due to their exceptionally high starting torque. In the PM electrical machines, rotor windings are replaced by permanent magnets due to their requirement for a continuous supply of electrical energy to produce and maintain magnetic fields. Additionally, the intricate and challenging construction of rotor windings demands extreme precision when inserting them into the magnetic slots of a rotor assembly.

Conventionally, during assembly of the rotor in the PM electrical machines, the permanent magnets (which are magnetized earlier) are inserted into a plurality of slots of the rotor assembly. The plurality of slots positioned around a rotor shaft and acts as a housing for the permanent magnets. Since the rotor assembly is a magnetic material, the permanent magnets are attracted to the rotor assembly, so the assembly of the permanent magnets into the rotor assembly is a complex task that may end up with operator fatigue. The assembly process requires a lot of automotive tools and techniques (for holding and pressing) to place the permanent magnets into the plurality of slots flawlessly, which increases the cost and complexity of the system.

The permanent magnets are very sensitive to heat and vibration. When the permanent magnets are exposed to heat then the permanent magnets will be demagnetized. So extra care needs to be provided to the permanent magnets, which make the transporting and handling processes difficult. At the time of assembly, there is a chance of placing the permanent magnets in an incorrect pole orientation, so there is a need for trained professionals. Furthermore, additional mechanisms are needed to separate the permanent magnets.

In existing systems, automobile manufacturers avoid using permanent magnets (which are magnetized earlier) in the rotor assembly of the electrical machines. Instead of using permanent magnets, automobile manufacturers use filling and molding of the liquid magnetic materials into the magnetic slots of the rotor assembly. At the same time, filling and molding of the liquid magnetic materials require molding machines such as injection molding machines which make the system costlier. Further, while filing and molding liquid magnetic materials, many parameters such as orientation intensity, applying time, and applying method need to be taken care of.

In other existing systems, the rotor assembly is constructed as a single part, which results in high eddy current losses. In other existing systems, the permanent magnets are derated due to heat generated by the rotation of the rotor assembly. In other existing systems, the rotor assembly is constructed as one or more parts due to the brittle nature of the magnets, then assembled the one or more parts to construct the rotor assembly. In this approach, positioning the same poles (N-N, or S-S) of the magnets together in a longitudinal axis of the rotor assembly is difficult.

In addition to that, in other existing systems, automobile manufacturers use a multi-step magnetization approach in which all north poles (N) will be magnetized in a different step of magnetization, and all south poles (S) will be magnetized in a different step of magnetization. The multi-step magnetization leads to uneven Tesla values in the north (N) and the south poles (S) of the rotor assembly. The rotor assembly with uneven Tesla values leads to imbalanced polarization, wear and tear issues, voltage harmonics, and low efficiency. Further, the uneven Tesla values may lead to torque variation in the rotor assembly, so the torque variation in the rotor assembly may create vibration. The conventional and existing systems are not efficient enough to solve the above-mentioned issues of constructing the electrical machine.

Accordingly, there remains a need for an improved system and method for magnetizing one or more rare earth metals to construct a rotor assembly of an electrical machine and therefore address the aforementioned issues.

### SUMMARY

In view of the foregoing, an embodiment herein provides a system to magnetize one or more rare earth metals to construct a rotor assembly. The system includes one or more laminated sheets. The one or more laminated sheets are stacked together to construct a laminated block. The one or more laminated blocks are stacked together to construct the rotor assembly. The rotor assembly includes one or more surfaces on an outer periphery of the rotor assembly. The rotor assembly includes one or more slots mechanically configured to provide a predetermined space to position the one or more rare earth metals in a non-magnetized state. The system further includes a magnetization unit. The magnetization unit includes one or more magnetizing surfaces and one or more magnetizing windings. The one or more magnetizing surfaces are configured to magnetize the one or more rare earth metals of the rotor assembly by passing a predetermined supply using the one or more magnetizing windings.

In one embodiment, the one or more magnetizing windings include different polarities. The one or more magnetizing windings with different polarities are configured to magnetize the one or more rare earth metals in a manner that one or more adjacent magnetic poles of the rotor assembly are opposite (N-S, S-N).

In another embodiment, the one or more surfaces of the rotor assembly include a first predetermined shape. The one or more magnetizing surfaces of the magnetization unit include a second predetermined shape.

In yet another embodiment, the first predetermined shape and the second predetermined shape are constructed in a manner to position each other to avoid wrong positioning of the rotor assembly with the magnetization unit. In yet another embodiment, the one or more surfaces of the rotor assembly are positioned at a predetermined distance from the one or more magnetizing surfaces of the magnetization unit.

In yet another embodiment, the predetermined distance varies based on the outer periphery of the rotor assembly, positioning of the first predetermined shape of the one or more surfaces, the second predetermined shape of the one or more magnetizing surfaces, and orientation of the one or more rare earth metals.

In yet another embodiment, the magnetization unit further includes one or more flux concentrators. The one or more flux concentrators are configured to separate the one or more magnetizing surfaces of a north pole (N), and the one or more magnetizing surfaces of a south pole (S). The one or more surfaces of the rotor assembly, the one or more flux concentrators, and the one or more magnetizing surfaces of the magnetization unit are configured to converge magnetic flux lines from the magnetization unit to the one or more rare earth metals that are positioned on the one or more slots of the rotor assembly

In yet another embodiment, the magnetization unit is configured to equally magnetize the one or more rare earth metals of the rotor assembly at once in a manner the one or more adjacent magnetic poles of the rotor assembly are opposite (N-S, S-N).

In another aspect, a method of magnetizing one or more rare earth metals to construct a rotor assembly is provided. The method includes the following steps: (a) stacking one or more laminated sheets together to construct a laminated block; (b) positioning the one or more rare earth metals into one or more slots; (c) gluing the one or more rare earth metals into the one or more slots; (d) stacking, using one or more joining processes, one or more laminated blocks in presence of a rotor shaft to construct the rotor assembly with one or more balancing rings; (e) balancing the rotor assembly that includes one or more surfaces on an outer periphery; (f) disposing of the rotor assembly into a magnetization unit that the magnetization unit includes one or more magnetizing surfaces, and one or more magnetizing windings; (g) correspondingly positioning the first predetermined shape and the second predetermined shape together in a manner to avoid wrong positioning of the rotor assembly with the magnetization unit; (h) positioning the one or more surfaces of the rotor assembly at a predetermined distance from the one or more magnetizing surfaces of the magnetization unit; (i) converging magnetic flux lines from the magnetization unit to the one or more rare earth metals using the one or more surfaces of the rotor assembly, one or more flux concentrators, and the one or more magnetizing surfaces of the magnetization unit; and (j) magnetizing, using the one or more magnetizing windings, the one or more rare earth metals by passing a predetermined supply.

In another embodiment, the method further includes the following step: magnetizing, using the one or more magnetizing windings with different polarities, the one or more rare earth metals in a manner that one or more adjacent magnetic poles of the rotor assembly are opposite (N-S, S-N).

In another embodiment, the method further includes the following step: separating, using the one or more flux concentrators, the one or more magnetizing surfaces of a north pole (N), and the one or more magnetizing surfaces of a south pole (N).

In yet another embodiment, the method further includes the following step: equally magnetizing, using the magnetization unit, the one or more rare earth metals of the rotor assembly at once in a manner that the one or more adjacent magnetic poles of the rotor assembly are opposite (N-S, S-N).

In yet another embodiment, the one or more joining processes include a riveting process, a welding process, a clamping process, an interlocking process, a bonding process, and a fastening process.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modification.

### BRIEF DESCRIPTION OF THE DRAWINGS

The embodiments herein will be better understood from the following detailed description with reference to the drawings, in which:

FIG. 1A illustrates a system to magnetize one or more rare earth metals to construct a rotor assembly according to an embodiment herein;

FIG. 1B illustrates a top view of the rotor assembly with a magnetization unit according to an embodiment herein;

FIG. 1C illustrates a partial schematic cross-sectional view of the rotor assembly with the magnetization unit according to an embodiment herein;

FIG. 2A illustrates a top view of a laminated sheet of one or more laminated sheets of the rotor assembly according to an embodiment herein;

FIG. 2B illustrates an isometric view of a laminated block of the rotor assembly according to an embodiment herein;

FIG. 2C illustrates an isometric view of one or more laminated blocks of the rotor assembly according to an embodiment herein;

FIG. 3 illustrates an exploded view of an electrical machine of the system according to an embodiment herein; and

FIGS. 4A & 4B illustrate a method for magnetizing the one or more rare earth metals to construct the rotor assembly of FIG. 1 according to an embodiment herein.

### DETAILED DESCRIPTION OF PREFERRED EMBODIMENTS

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

Accordingly, embodiments herein disclose a system for magnetizing one or more rare earth metals to construct a rotor assembly. The system includes one or more laminated sheets. The one or more laminated sheets are stacked together to construct a laminated block. One or more laminated blocks are stacked together to construct the rotor assembly. The rotor assembly includes one or more surfaces on an outer periphery of the rotor assembly. The rotor assembly includes one or more slots mechanically configured to provide a predetermined space to position the one or more rare earth metals in a non-magnetized state.

The system includes a magnetization unit. The magnetization unit includes one or more magnetizing surfaces and one or more magnetizing windings. The one or more magnetizing surfaces are configured to magnetize the one or more rare earth metals of the rotor assembly by passing a predetermined supply using the one or more magnetizing windings.

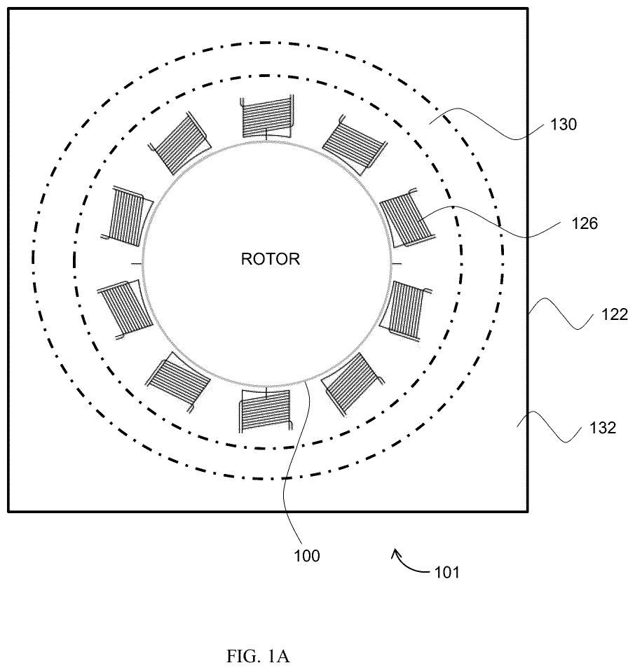

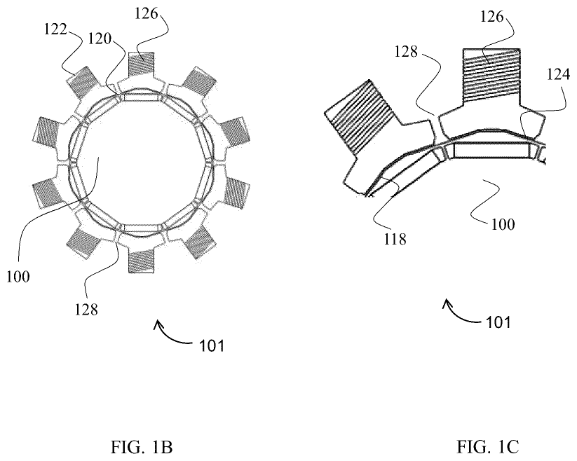

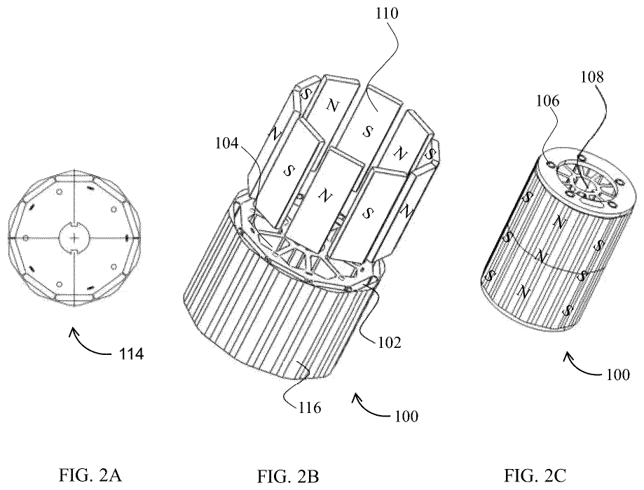

Referring now to the drawings, and more particularly FIGS. 1 to 4, where similar reference characters denote corresponding features consistently throughout the figures, there are shown as preferred embodiments.

FIG. 1A illustrates a system 101 to magnetize one or more rare earth metals 110 to construct a rotor assembly 100 according to an embodiment herein. The system 101 includes one or more laminated sheets 114. The one or more laminated sheets 114 are stacked together using one or more connecting means. Each of the one or more laminated sheets 114 includes the one or more connecting means. The one or more connecting means are configured to stack the one or more laminated sheets 114 together. The one or more laminated sheets 114 are stacked together to construct a laminated block 116. One or more laminated blocks 116 are stacked together to construct the rotor assembly 100.

The rotor assembly 100 includes one or more slots 102, one or more weight reduction cut-outs 104, one or more balancing rings 106, and a shaft slot 108. The one or more slots 102 are mechanically configured to provide a predetermined space to position the one or more rare earth metals 110 in a non-magnetized state. In one embodiment, the one or more slots 102 may vary in number and size based on an output requirement of the electrical machine. In one embodiment, the electrical machine may include, but not limited to, a mid-drive electrical machine and a hub electrical machine. In another embodiment, the electrical machine may include, but not limited to, an interior permanent magnet (IPM) electrical machine and a surface permanent magnet (SPM) electrical machine.

The one or more weight reduction cut-outs 104 are positioned in a predetermined location of the rotor assembly 100 to reduce weight of the rotor assembly 100. In one embodiment, the predetermined location of the one or more weight reduction cut-outs 104 may be an axial and a longitudinal surface of the rotor assembly 100. The one or more rare earth metals 110 may be inserted into the one or more slots 102 of the one or more laminated blocks 116. In yet another embodiment, a shape of the one or more rare earth metals 110 may include, but not limited to, a slab, a bar, or a cylinder. In yet another embodiment, the one or more rare earth metals 110 may be in a solid state or liquid state. The rotor assembly 100 includes one or more surfaces 118 on an outer periphery 120 of the rotor assembly 100. The one or more surfaces 118 include a first predetermined shape.

Furthermore, the system 101 includes a magnetization unit 122. The magnetization unit 122 includes one or more magnetizing surfaces 124 and one or more magnetizing windings 126. The one or more magnetizing surfaces 124 are configured to magnetize the one or more rare earth metals 110 of the rotor assembly 100 by passing a predetermined supply using the one or more magnetizing windings 126. In one embodiment, the predetermined supply may vary based on type of the one or more rare earth materials. In yet another embodiment, the type of the one or more rare earth materials may vary based on the application.

The predetermined supply may vary based on requirements. In one embodiment, the magnetization unit 122 is configured to control the predetermined supply using one or more sensing means. The one or more magnetizing surfaces 124 of the magnetization unit 122 include a second predetermined shape. The first predetermined shape and the second predetermined shape are constructed in a manner to position each other to avoid wrong positioning of the rotor assembly 100 with the magnetization unit 122.

The one or more surfaces 118 of the rotor assembly 100 are positioned at a predetermined distance from the one or more magnetizing surfaces 124 of the magnetization unit 122. In one embodiment, the predetermined distance may vary based on varies based on the outer periphery 120 of the rotor assembly 100, positioning of the first predetermined shape of the one or more surfaces 118, the second predetermined shape of the one or more magnetizing surfaces 124, and orientation of the one or more rare earth metals 110.

The one or more magnetizing windings 126 include different polarities. In one embodiment, the different polarities of the one or more magnetizing windings 126 include a positive polarity and a negative polarity. The one or more magnetizing windings 126 with different polarities are configured to magnetize the one or more rare earth metals 110 in a manner that one or more adjacent magnetic poles of the rotor assembly 100 are opposite (N-S, S-N).

In addition to that, the magnetization unit 122 includes one or more flux concentrators 128. The one or more flux concentrators 128 are configured to separate the one or more magnetizing surfaces 124 of a north pole (N), and the one or more magnetizing surfaces 124 of a south pole (S). The one or more magnetizing surfaces 124 of the rotor assembly 100, the one or more flux concentrators 128, and the one or more magnetizing surfaces 124 of the magnetization unit 122 are configured to converge magnetic flux lines from the magnetization unit 122 to the one or more rare earth metals 110 that are positioned on the one more slots 102 of the rotor assembly 100. In one embodiment, the one or more flux concentrators 128 are made up of one or more non-magnetic substances. In one embodiment, the one or more non-magnetic substances may include, but not limited to, wood, plastic, copper, paper, aluminum, rubber, and stone. In one embodiment, the one or more flux concentrators 128 may be air.

The one or more rare earth metals 110 are glued to the one or more laminated blocks 116 using glue. In one embodiment, the one or more rare earth metals 110 are clamped to one or more laminated blocks 116 using one or more clamps. In one embodiment, the glue is applied to the one or more rare earth metals 110 and then inserted into the one or more slots 102. The one or more laminated blocks 116 are joined together with help of the one or more balancing rings 106 using one or more joining processes. In one embodiment, the one or more joining processes may include, but not limited to, a riveting process, a welding process, a clamping process, an interlocking process, a bonding process, and a fastening process.

A rotor shaft is positioned into the shaft slot 108. In one embodiment, the rotor shaft is positioned into the shaft slot 108 using one or more assembling techniques. In one embodiment, the one or more assembling techniques may include, but not limited to, a press-fitting process. As used herein, the press-fitting process is an assembly in which one part is inserted tightly into a hole in another part. The inserted part is typically larger than the mating hole. The assembly stays in place through friction and the force of the two parts pushing against each other.

Furthermore, the rotor assembly 100 is positioned into the magnetization unit 122 to magnetize the one or more rare earth metals 110. The magnetization unit 122 further includes a cooling unit 130, and an insulation unit 132. The cooling unit 130 is configured to dissipate heat energy generated at the one or more magnetizing windings 126 while passing the predetermined supply to the one or more rare earth metals 110. The insulation unit 132 is configured to avoid magnetic flux (generated at the time of magnetization) scattering outside of the magnetization unit 122. In one embodiment, the one or more magnetizing windings 126 with different polarities are configured to magnetize the one or more rare earth metals 110 at once in a manner that the one or more adjacent magnetic poles of the rotor assembly 100 are opposite (N-S, S-N). The rotor assembly 100 with one or more magnetized rare earth metals is placed into a stator to form the electrical machine.

FIG. 1B illustrates a top view of the rotor assembly 100 with a magnetization unit 122 according to an embodiment herein. The magnetization unit 122 includes the one or more magnetizing surfaces 124, and the one or more magnetizing windings 126. The one or more magnetizing surfaces 124 are configured to magnetize the one or more rare earth metals 110 of the rotor assembly 100 by passing the predetermined supply using the one or more magnetizing windings 126. In one embodiment, the predetermined supply may vary based on type of the one or more rare earth materials. In yet another embodiment, the type of the one or more rare earth materials may vary based on the application.

The predetermined supply may vary based on requirements. In one embodiment, the magnetization unit 122 is configured to control the predetermined supply using one or more sensing means. The rotor assembly 100 includes the one or more surfaces 118 on the outer periphery 120 of the rotor assembly 100. The one or more surfaces 118 include a first predetermined shape.

The one or more magnetizing surfaces 124 of the magnetization unit 122 include a second predetermined shape. The first predetermined shape and the second predetermined shape are constructed in a manner to position each other to avoid wrong positioning of the rotor assembly 100 with the magnetization unit 122.

The one or more surfaces 118 of the rotor assembly 100 are positioned at a predetermined distance from the one or more magnetizing surfaces 124 of the magnetization unit 122. In one embodiment, the predetermined distance may vary based on varies based on the outer periphery 120 of the rotor assembly 100, positioning of the first predetermined shape of the one or more surfaces 118, the second predetermined shape of the one or more magnetizing surfaces 124, and orientation of the one or more rare earth metals 110.

The one or more magnetizing windings 126 include different polarities. In one embodiment, the different polarities of the one or more magnetizing windings 126 include a positive polarity and a negative polarity. The one or more magnetizing windings 126 with different polarities are configured to magnetize the one or more rare earth metals 110 in a manner that one or more adjacent magnetic poles of the rotor assembly 100 are opposite (N-S, S-N).

In addition to that, the magnetization unit 122 includes the one or more flux concentrators 128. The one or more flux concentrators 128 are configured to separate the one or more magnetizing surfaces 124 of a north pole (N), and the one or more magnetizing surfaces 124 of a south pole (S). The one or more magnetizing surfaces 124 of the rotor assembly 100, the one or more flux concentrators 128, and the one or more magnetizing surfaces 124 of the magnetization unit 122 are configured to converge magnetic flux lines from the magnetization unit 122 to the one or more rare earth metals 110 that are positioned on the one more slots 102 of the rotor assembly 100. In one embodiment, the one or more flux concentrators 128 are made up of one or more non-magnetic substances. In one embodiment, the one or more non-magnetic substances may include, but not limited to, wood, plastic, copper, paper, aluminum, rubber, and stone. In one embodiment, the one or more flux concentrators 128 may be air. The rotor assembly 100 is positioned into the magnetization unit 122 to magnetize the one or more rare earth metals 110.

FIG. 1C illustrates a partial schematic cross-sectional view of the rotor assembly 100 with the magnetization unit 122 according to an embodiment herein. The magnetization unit 122 includes the one or more magnetizing surfaces 124, and the one or more magnetizing windings 126. The one or more magnetizing surfaces 124 are configured to magnetize the one or more rare earth metals 110 of the rotor assembly 100 by passing the predetermined supply using the one or more magnetizing windings 126. In one embodiment, the predetermined supply may vary based on type of the one or more rare earth materials. In yet another embodiment, the type of the one or more rare earth materials may vary based on the application.

The predetermined supply may vary based on requirements. In one embodiment, the magnetization unit 122 is configured to control the predetermined supply using one or more sensing means. The one or more magnetizing surfaces 124 of the magnetization unit 122 include a second predetermined shape. The first predetermined shape and the second predetermined shape are constructed in a manner to position each other to avoid wrong positioning of the rotor assembly 100 with the magnetization unit 122.

The one or more surfaces 118 of the rotor assembly 100 are positioned at a predetermined distance from the one or more magnetizing surfaces 124 of the magnetization unit 122. In one embodiment, the predetermined distance may vary based on varies based on the outer periphery 120 of the rotor assembly 100, positioning of the first predetermined shape of the one or more surfaces 118, the second predetermined shape of the one or more magnetizing surfaces 124, and orientation of the one or more rare earth metals 110.

In addition to that, the magnetization unit 122 includes the one or more flux concentrators 128. The one or more flux concentrators 128 are configured to separate the one or more magnetizing surfaces 124 of a north pole (N), and the one or more magnetizing surfaces 124 of a south pole (S). The one or more magnetizing surfaces 124 of the rotor assembly 100, the one or more flux concentrators 128, and the one or more magnetizing surfaces 124 of the magnetization unit 122 are configured to converge magnetic flux lines from the magnetization unit 122 to the one or more rare earth metals 110 that are positioned on the one more slots 102 of the rotor assembly 100. In one embodiment, the one or more flux concentrators 128 are made up of one or more non-magnetic substances. In one embodiment, the one or more non-magnetic substances may include, but not limited to, wood, plastic, copper, paper, aluminum, rubber, and stone. In one embodiment, the one or more flux concentrators 128 may be air.

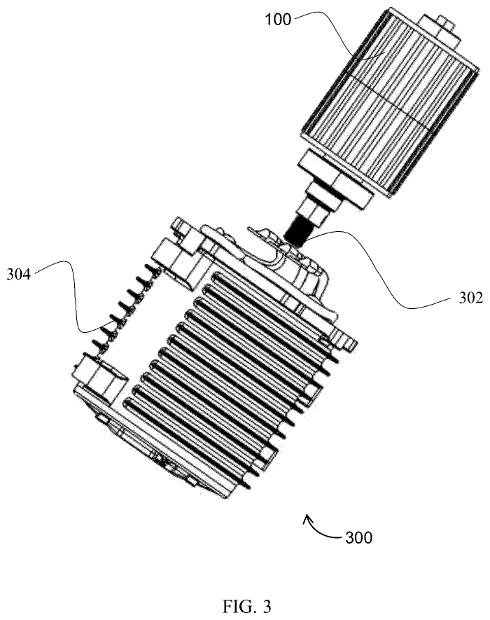

FIG. 2A illustrates a top view of a laminated sheet 114 of one or more laminated sheets 114 of the rotor assembly 100 according to an embodiment herein. The system 101 includes the one or more laminated sheets 114. The one or more laminated sheets 114 are stacked together to construct the laminated block 116. The one or more laminated blocks 116 are stacked together to construct the rotor assembly 100.

FIG. 2B illustrates an isometric view of the laminated block 116 of the rotor assembly 100 according to an embodiment herein. The laminated block 116 of the rotor assembly 100 includes the one or more slots 102. The one or more slots 102 are mechanically configured to provide a predetermined space to position the one or more rare earth metals in a non-magnetized state. The one or more rare earth metals 110 are magnetized using the magnetization unit 122. An adjacent pole of the north pole (N) will be the south pole (S).

FIG. 2C illustrates an isometric view of the one or more laminated blocks 116 of the rotor assembly 100 according to an embodiment herein. The one or more laminated blocks 116 are stacked together to construct the rotor assembly 100. The one or more laminated blocks 116 are arranged and magnetized in such a way that the same poles (N-N, S-S) will be positioned together in a longitudinal axis. The one or more balancing rings 106 are configured to arrange the one or more laminated blocks 116 together with the help of the one or more joining processes. In one embodiment, the one or more joining processes may include, but not limited to, a riveting process, a welding process, a clamping process, an interlocking process, a bonding process, and a fastening process.

The one or more magnets are longitudinally positioned in the plurality of magnetic slots as the same poles (N-N, S-S) with the help of glue. In one embodiment, the one or more rare earth metals 110 are clamped to the one or more laminated blocks 116 using one or more clamps.

FIG. 3 illustrates an exploded view of an electrical machine 300 of the system 101 according to an embodiment herein. The electrical machine 300 of FIG. 3 shows the rotor assembly 100 with a stator 304. A rotor shaft 302 of the rotor assembly 100 is positioned in the shaft slot 108. In one embodiment, the rotor shaft 302 of the rotor assembly 100 is positioned in the shaft slot 108 using a press fitting process. As used herein, the press-fitting process is an assembly in which one part is inserted tightly into a hole in another part. The inserted part is typically larger than the mating hole. The assembly stays in place through friction and the force of the two parts pushing against each other. Further, FIG. 3 explicitly shows the placement/assembly of the rotor assembly 100 with the one or more magnetized rare earth metals into the stator 304 to form an electrical machine.

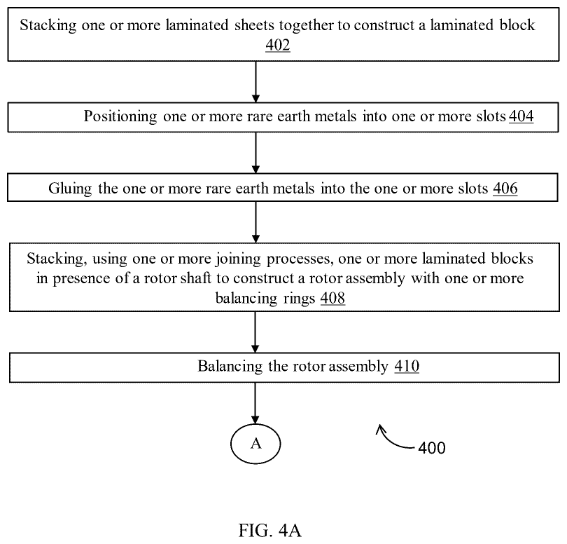

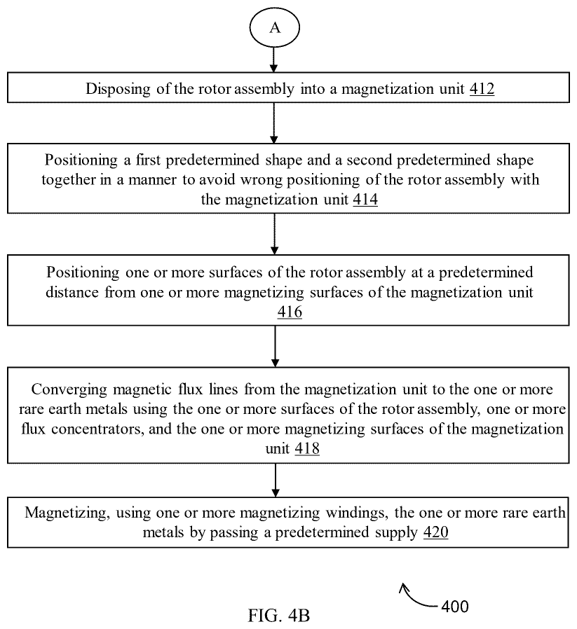

FIGS. 4A & 4B illustrate a method 400 for magnetizing the one or more rare earth metals 110 to construct the rotor assembly 100 of FIG. 1 according to an embodiment herein. At step 402, stacking one or more laminated sheets 114 together to construct a laminated block 116. Each of the one or more laminated sheets 114 includes the one or more connecting means. The one or more connecting means are configured to stack the one or more laminated sheets 114 together.

At step 404, positioning the one or more rare earth metals 110 into one or more slots 102. At step 406, gluing the one or more rare earth metals 110 into the one or more slots 102. In one embodiment, the glue is applied to the one or more rare earth metals 110 and then inserted into the one or more slots 102. In one embodiment, the one or more rare earth metals 110 are clamped to one or more laminated blocks 116 using one or more clamps.

At step 408, stacking, using one or more joining processes, the one or more laminated blocks 116 in the presence of a rotor shaft 302 to construct the rotor assembly 100 with one or more balancing rings 106. The rotor assembly 100 includes one or more surfaces 118 on an outer periphery 120 of the rotor assembly 100. The one or more surfaces 118 of the rotor assembly 100 include a first predetermined shape. In one embodiment, the one or more joining processes may include, but not limited to, a riveting process, a welding process, a clamping process, an interlocking process, a bonding process, and a fastening process.

At step 410, balancing the rotor assembly 100. The one or more balancing rings 106 are configured to arrange the one or more laminated blocks 116 together with the help of the one or more joining processes. In one embodiment, the one or more joining processes may include, but not limited to, a riveting process, a welding process, a clamping process, an interlocking process, a bonding process, and a fastening process.

At step 412, disposing of the rotor assembly 100 into a magnetization unit 122. The magnetization unit 122 includes one or more magnetizing surfaces 124 and one or more magnetizing windings 126. The one or more magnetizing surfaces 124 of the magnetization unit 122 comprise a second predetermined shape.

At step 414, correspondingly positioning the first predetermined shape and the second predetermined shape together in a manner to avoid wrong positioning of the rotor assembly 100 with the magnetization unit 122.

At step 416, positioning the one or more surfaces 118 of the rotor assembly 100 at a predetermined distance from the one or more magnetizing surfaces 124 of the magnetization unit 122. In one embodiment, the predetermined distance varies based on the outer periphery of the rotor assembly 100, positioning of the first predetermined shape of the one or more surfaces 118 and the second predetermined shape of the one or more magnetizing surfaces 124, and orientation of the one or more rare earth metals 110. In another embodiment, the magnetization unit 122 further includes one or more flux concentrators 128.

At step 418, converging magnetic flux lines from the magnetization unit 122 to the one or more rare earth metals 110 using the one or more surfaces 118 of the rotor assembly 100, the one or more flux concentrators 128, and the one or more magnetizing surfaces 124 of the magnetization unit 122. In one embodiment, the one or more magnetizing windings 126 include different polarities. At step 420, magnetizing, using the one or more magnetizing windings 126, the one or more rare earth metals 110 by passing a predetermined supply. The one or more magnetizing windings 126 include different polarities. The different polarities include a positive polarity and a negative polarity. The method 400 further includes magnetizing, using the one or more magnetizing windings 126 with different polarities, the one or more rare earth metals 110 in a manner that one or more adjacent magnetic poles of the rotor assembly 100 are opposite (N-S, S-N).

The method 400 further includes separating the one or more magnetizing surfaces 124 of a north pole (N), and the one or more magnetizing surfaces 124 of a south pole (S) using the one or more flux concentrators 128. The method 400 further includes equally magnetizing the one or more rare earth metals 110 of the rotor assembly 100 at once using the magnetization unit 122 in a manner that the one or more adjacent magnetic poles of the rotor assembly 100 are opposite (N-S, S-N).

The system 101 does not require skilled professionals for magnet insertion to ensure an alternate pole. The proposed system 101 does not require an additional mechanism to check the alternate poles. The system 101 eliminates positioning of wrong polarity magnets which leads to defective rotor assembly 100 and may cause rejection of the rotor assembly 100 and internal process defect cost. In addition to, that, the system 101 makes easy packaging, storage, and transportation of the plurality of rare earth material 110 when it compares magnetized magnets. The system 101 provides easy handling from the electrical machine assembly line up to the magnetization station. No or less wear of coating material on the Magnet leads to more corrosion & and wear resistance. The system 101 reduces overall assembly time due to the non-magnetized magnet's ease of handling. The system 101 provides ease in the one or more balancing rings 106, the one or more joining processes, the rotor shaft, and balancing station. Since it is the one or more rare earth metals 110 the glue application is easier and uniform because of no attraction forces between the core and magnet. Minimized repulsive force acting between the equally divided stacks due to the one or more rare earth metals 110 helps in the one or more joining processes. Furthermore, no or minimum gaps formed between the equally divided stacks. The system 101 ensures and increases the safety of the operator during material handling of the one or more rare earth metals 110 when compared to magnetized magnets.

The system 101 provides a solution for derating problems that occur due to heat generated by rotation of the electrical machine by repeating the magnetization process. Furthermore, the system 101 provides a solution to the problems that occur while the positioning the same poles (N-N, or S-S) of the magnets together in the longitudinal axis of the rotor assembly 100 by inserting the one or more rare earth metals 110 into the one or more slots 102 of the rotor assembly 100 in a non-magnetized state. In addition to that, the system 101 ensures to equal Tesla value of the one or more magnetized rare earth metals through single-shot magnetization, in order to avoid imbalanced polarization, wear and tear issues, voltage harmonics, and low efficiency. Further, the system 101 controls the vibration issues by avoiding torque variation in the rotor assembly 100. The torque variation is reduced by the single-shot magnetization.

In addition to that, the system 101 reduces voltage harmonics of the electrical machine by providing the one or more surfaces 118 on the outer periphery 120 of the rotor assembly 100 instead of circular rotor. Each of the one or more rare earth metals 110 provided with the predetermined supply using the one or more magnetizing windings 126 of the magnetization unit 122. The one or more magnetizing windings 126 include different polarities to magnetize adjacent magnetic poles of the rotor assembly 100 are opposite (N-S, S-N). The system 101 reduces eddy current loss in the electrical machine by constructing the rotor assembly 100 as a multi-part assembly.

Furthermore, the system 101 provides an approach to magnetize the one or more rare earth metals 110 with efficient Tesla values. The tesla value of the one or more magnetized rare earth metals may be varied based on the type of the one or more rare earth metals 110, and the predetermined supply from the one or more magnetizing windings 126 of the magnetization unit 122.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims. Improvements and modifications may be incorporated herein without deviating from the scope of the invention.

### LIST OF REFERENCE NUMERALS

System—101
Rotor assembly—100
One or more slots—102
One or more weight reduction cut-outs—104
One or more balancing rings—106
Shaft slot—108
One or more rare earth metals—110
One or more laminated sheets—114
Laminated block or the One or more laminated blocks—116
One or more surfaces—118
Outer periphery—120
Magnetization unit—122
One or more magnetizing surfaces—124
One or more magnetizing windings—126
One or more flux concentrators—128
Cooling unit—130
Insulation unit—132
Rotor shaft—302
Stator—304.

1-13. (canceled)

14. A system to magnetize one or more rare earth metals to construct a rotor assembly, comprising:
one or more laminated sheets are stacked together to construct a laminated block;
one or more laminated blocks stacked together to construct the rotor assembly, wherein the rotor assembly comprises one or more surfaces on an outer periphery of the rotor assembly;
the rotor assembly comprises one or more slots mechanically configured to provide a predetermined space to position the one or more rare earth metals in a non-magnetized state; and
a magnetization unit comprises one or more magnetizing surfaces, and one or more magnetizing windings, wherein the one or more magnetizing surfaces are configured to magnetize the one or more rare earth metals of the rotor assembly by passing a predetermined supply using the one or more magnetizing windings.

15. The system as claimed in claim 14, wherein the one or more magnetizing windings comprise different polarities, wherein the one or more magnetizing windings with different polarities configured to magnetize the one or more rare earth metals in a manner one or more adjacent magnetic poles of the rotor assembly are opposite (N-S, S-N).

16. The system as claimed in claim 14, wherein the one or more surfaces of the rotor assembly comprise a first predetermined shape, wherein the one or more magnetizing surfaces of the magnetization unit comprise a second predetermined shape.

17. The system as claimed in claim 16, wherein the first predetermined shape and the second predetermined shape are constructed in a manner to position each other to avoid wrong positioning of the rotor assembly with the magnetization unit.

18. The system as claimed in claim 14, wherein the one or more surfaces of the rotor assembly are positioned at a predetermined distance from the one or more magnetizing surfaces of the magnetization unit.

19. The system as claimed in claim 18, wherein the predetermined distance varies based on the outer periphery of the rotor assembly, positioning of the first predetermined shape of the one or more surfaces, and the second predetermined shape of the one or more magnetizing surfaces and orientation of the one or more rare earth metals.

20. The system as claimed in claim 14, wherein the magnetization unit further comprises one or more flux concentrators, wherein the one or more flux concentrators are configured to separate the one or more magnetizing surfaces of a north pole (N), and the one or more magnetizing surfaces of a south pole (S), wherein the one or more surfaces of the rotor assembly, the one or more flux concentrators, and the one or more magnetizing surfaces of the magnetization unit are configured to converge magnetic flux lines from the magnetization unit to the one or more rare earth metals that are positioned on the one more slots of the rotor assembly.

21. The system as claimed in claim 14, wherein the magnetization unit is configured to equally magnetize the one or more rare earth metals of the rotor assembly at once in a manner the one or more adjacent magnetic poles of the rotor assembly are opposite (N-S, S-N).

22. A method of magnetizing one or more rare earth metals to construct a rotor assembly, comprising:
stacking one or more laminated sheets together to construct a laminated block;
positioning the one or more rare earth metals into one or more slots;
gluing the one or more rare earth metals into the one or more slots;
stacking, using one or more joining processes, one or more laminated blocks in presence of a rotor shaft 302 to construct the rotor assembly with one or more balancing rings;
balancing the rotor assembly, wherein the rotor assembly comprises one or more surfaces on an outer periphery, wherein the one or more surfaces of the rotor assembly comprise a first predetermined shape;
disposing of the rotor assembly into a magnetization unit, wherein the magnetization unit comprises one or more magnetizing surfaces, and one or more magnetizing windings, wherein the one or more magnetizing surfaces of the magnetization unit comprise a second predetermined shape;
correspondingly positioning the first predetermined shape and the second predetermined shape together in a manner to avoid wrong positioning of the rotor assembly with the magnetization unit;
positioning the one or more surfaces of the rotor assembly at a predetermined distance from the one or more magnetizing surfaces of the magnetization unit, wherein the predetermined distance varies based on the outer periphery of the rotor assembly, positioning of the first predetermined shape of the one or more surfaces and the second predetermined shape of the one or more magnetizing surfaces and orientation of the one or more rare earth metals;
converging magnetic flux lines from the magnetization unit to the one or more rare earth metals using the one or more surfaces of the rotor assembly, one or more flux concentrators, and the one or more magnetizing surfaces of the magnetization unit, wherein the magnetization unit further comprises the one or more flux concentrators; and
magnetizing, using the one or more magnetizing windings, the one or more rare earth metals by passing a predetermined supply, wherein the one or more magnetizing windings comprise different polarities.

23. The method as claimed in claim 22, wherein the method further comprises:
magnetizing, using the one or more magnetizing windings with different polarities, the one or more rare earth metals in a manner one or more adjacent magnetic poles of the rotor assembly are opposite (N-S, S-N).

24. The method as claimed in claim 22, wherein the method further comprises:
separating, using the one or more flux concentrators, the one or more magnetizing surfaces of a north pole (N), and the one or more magnetizing surfaces of a south pole (N).

25. The method as claimed in claim 22, wherein the method further comprises: equally magnetizing, using the magnetization unit, the one or more rare earth metals of the rotor assembly at once in a manner the one or more adjacent magnetic poles of the rotor assembly are opposite (N-S, S-N).

26. The method as claimed in claim 22, wherein the one or more joining processes comprises a riveting process, a welding process, a clamping process, an interlocking process, a bonding process, and a fastening process.
